(19) United States
(12) Patent Application Publication
(10) Pub. No.: US 2024/0259784 A1
(43) Pub. Date: Aug. 1, 2024

(54) TERMINAL AND COMMUNICATION METHOD

(71) Applicant: NTT DOCOMO, INC., Tokyo (JP)

(72) Inventors: Masato Taniguchi, Chiyoda-ku, Tokyo (JP); Yuuya Hoshizaki, Chiyoda-ku, Tokyo (JP); Tianyang Min, Chiyoda-ku, Tokyo (JP)

(73) Assignee: NTT DOCOMO, INC., Tokyo (JP)

(21) Appl. No.: 18/560,615

(22) PCT Filed: Jun. 29, 2021
(86) PCT No.: PCT/JP2021/024608

§ 371 Date: Nov. 13, 2023

(51) Int. Cl. H04W 8/22; H04L 5/00; H04W 76/15

(52) U.S. Cl. CPC H04W 8/22; H04L 5/001; H04W 76/15

(57) ABSTRACT

A terminal includes: a reception unit configured to receive an inquiry related to terminal capability including bands and a parameter from a first base station, the bands being supported by a second base station that performs communication together with the first base station according to DC (Dual Connectivity) and the parameter being supported by the second base station in the bands; a control unit configured to determine the terminal capability corresponding to the bands and the parameter; and a transmission unit configured to transmit a report related to the determined terminal capability to the first base station.

### FIELD OF THE INVENTION

The present invention relates to a terminal and a communication method in a wireless communication system.

### BACKGROUND OF THE INVENTION

In 3GPP (3rd Generation Partnership Project), in order to realize further larger system capacity, further faster data transmission speed, further lower latency in a wireless communication section, etc., a wireless communication method called “5G” or “NR (New Radio)” has been discussed (hereinafter, the wireless communication method is referred to as “NR”). In 5G, various wireless technologies and network architectures are being discussed to satisfy the requirement of a radio link delay of 1 ms or less while achieving throughput of 10 Gbps or more (e.g., non-patent document 1).

In LTE (Long Term Evolution) and NR, EN-DC (EUTRA-NR Dual Connectivity) is supported. With respect to the UE capability for EN-DC, signaling is reduced by indicating, by the eNB, the target bands, a bandwidth of each band, a number of component carriers, and the like, and by reporting, from the UE to the eNB, only corresponding bands. The eNB determines band combinations that can be used by the gNB, based on the report from the UE and indicates the determined band combinations to the gNB.

### CITATION LIST

### Non-Patent Document

Non-Patent Document 1: 3GPP TS 38.300 V16.5.0 (2021-03)
Non-Patent Document 2: 3GPP TS 38.213 V16.5.0 (2021-03)

### SUMMARY OF THE INVENTION

### Technical Problem

In EN-DC, when the eNB determines band combinations that can be used by the gNB, the eNB does not refer to the NR-specific UE capability. As a result, there is a case in which a band combination that is not supported by the gNB is determined, and thus, there is a case in which the gNB cannot be added as a secondary node.

The present invention has been made in view of the above points, and it is an object of the present invention to improve reliability when adding a secondary node in a wireless communication system.

### Solution to Problem

According to the disclosed technique, a terminal is provided. The terminal includes: a reception unit configured to receive an inquiry related to terminal capability including bands and a parameter from a first base station, the bands being supported by a second base station that performs communication together with the first base station according to DC (Dual Connectivity) and the parameter being supported by the second base station in the bands; a control unit configured to determine the terminal capability corresponding to the bands and the parameter; and a transmission unit configured to transmit a report related to the determined terminal capability to the first base station.

### Advantageous Effects of Invention

According to the disclosed technology, it is possible to improve reliability when adding a secondary node in a wireless communication system.

### BRIEF DESCRIPTION OF THE DRAWINGS

FIG. 1 is a drawing illustrating an example (1) of a wireless communication system according to an embodiment of the present invention.

FIG. 2 is a drawing illustrating an example (1) of a wireless communication system according to an embodiment of the present invention.

FIG. 3 is an example of adding a secondary node in an embodiment of the present invention.

FIG. 4 is a drawing illustrating an example of UE capability for NR in an embodiment of the present invention.

FIG. 5 is a drawing illustrating an example of a UE capability inquiry in an embodiment of the present invention.

FIG. 6 is a drawing illustrating an example of a functional structure of a base station 10 in an embodiment of the present invention.

FIG. 7 is a drawing illustrating an example of a functional structure of a terminal 20 in an embodiment of the present invention.

FIG. 8 is a drawing illustrating an example of a hardware structure of the base station 10 or the terminal 20 in an embodiment of the present invention.

### DETAILED DESCRIPTION OF THE PREFERRED EMBODIMENTS

In the following, referring to the drawings, one or more embodiments of the present invention will be described. It should be noted that the embodiments described below are examples. Embodiments of the present invention are not limited to the following embodiments.

In operations of a wireless communication system according to an embodiment of the present invention, conventional techniques will be used accordingly. The conventional techniques may be conventional NR or LTE, for example, but are not limited to conventional NR or LTE.

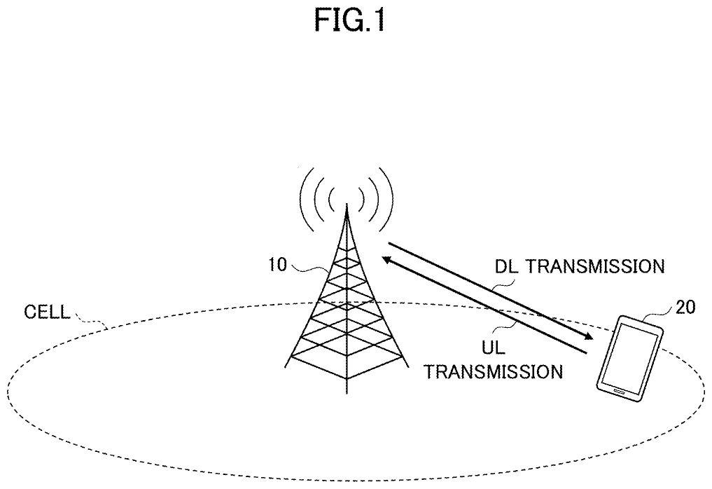

FIG. 1 is a drawing illustrating an example (1) of a wireless communication system according to an embodiment of the present invention. As illustrated in FIG. 1, a wireless communication system according to an embodiment of the present invention includes a base station 10 and a terminal 20. In FIG. 1, a single base station 10 and a single terminal 20 are illustrated as an example. There may be a plurality of base stations 10 and a plurality of terminals 20.

The base station 10 is a communication device that provides one or more cells and performs wireless communications with the terminal 20. Physical resources of the radio signal may be defined in the time domain and the frequency domain, the time domain may be defined by the number of OFDM symbols, and the frequency domain may be defined by the number of subcarriers or resource blocks. In addition, the TTI (Transmission Time Interval) in the time domain may be a slot, the TTI may be a subframe, or the TTI may be a unit of another name (for example, a subslot).

The base station 10 can perform carrier aggregation to communicate with the terminal 20 by bundling a plurality of cells (multiple CCs (component carriers)). One PCell (primary cell) and one or more SCells (secondary cells) are used in the carrier aggregation.

The base station 10 transmits a synchronization signal, system information, and the like, to the terminal 20. The synchronization signal is, for example, an NR-PSS and an NR-SSS. The system information may be transmitted via a NR-PBCH or a PDSCH, for example, and may be referred to as broadcast information. As shown in FIG. 1, the base station 10 transmits a control signal or data in DL (Downlink) to the terminal 20 and receives a control signal or data in UL (Uplink) from the terminal 20. Note that, here, what is transmitted via a control channel such as PUCCH (Physical Uplink Shared Channel) and PDCCH (Physical Downlink Control Channel) is called a control signal, and what is transmitted via a shared channel such as PUSCH (Physical Uplink Shared Channel) and PDSCH (Physical Downlink Shared Channel) is called data. However, these names are examples.

The terminal 20 may be a communication apparatus that includes a wireless communication function such as a smart-phone, a mobile phone, a tablet, a wearable terminal, a communication module for M2M (Machine-to-Machine), or the like. As shown in FIG. 1, the terminal 20 uses various communication services provided by the wireless communication system by receiving control signals or data in DL from the base station 10 and transmitting control signals or data in UL to the base station 10. Note that the terminal 20 may be referred to as a UE, and the base station 10 may be referred to as a gNB.

The terminal 20 can perform carrier aggregation to communicate with the base station 10 by bundling a plurality of cells (a plurality of CCs (component carriers)). One PCell (primary cell) and one or more SCells (secondary cells) are used in the carrier aggregation. In addition, PUCCH-SCell having PUCCH may be used.

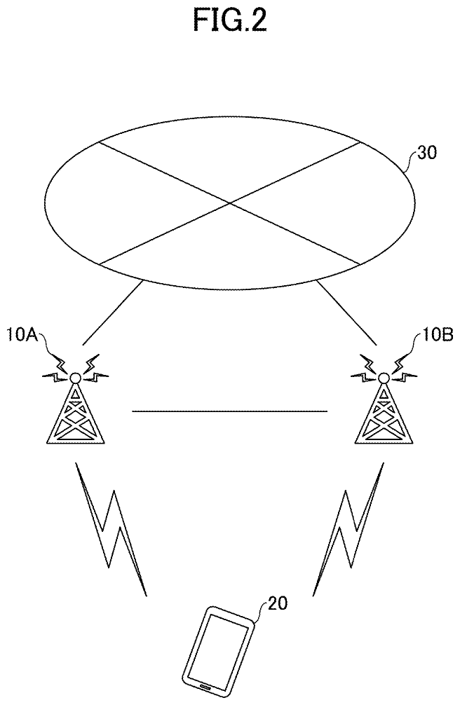

FIG. 2 is a drawing illustrating an example (2) of a wireless communication system according to an embodiment of the present invention. FIG. 2 shows an example of a configuration of a wireless communication system in a case where DC (Dual connectivity) is performed. As shown in FIG. 2, a base station 10A serving as an MN (Master Node) and a base station 10B serving as an SN (Secondary Node) are provided. The base station 10A and the base station 10B are each connected to a core network. The terminal 20 is enabled to communicate with both the base station 10A and the base station 10B.

A cell group provided by the base station 10A that is an MN is called an MCG (Master Cell Group), and a cell group provided by the base station 10B that is an SN is called an SCG (Secondary Cell Group). In addition, in DC, the MCG includes one PCell and one or more SCells, and the SCG includes one PSCell (Primary SCG Cell) and one or more SCells.

Processing operations in this embodiment may be performed in a system configuration shown in FIG. 1, in a system configuration shown in FIG. 2, or in other system configurations.

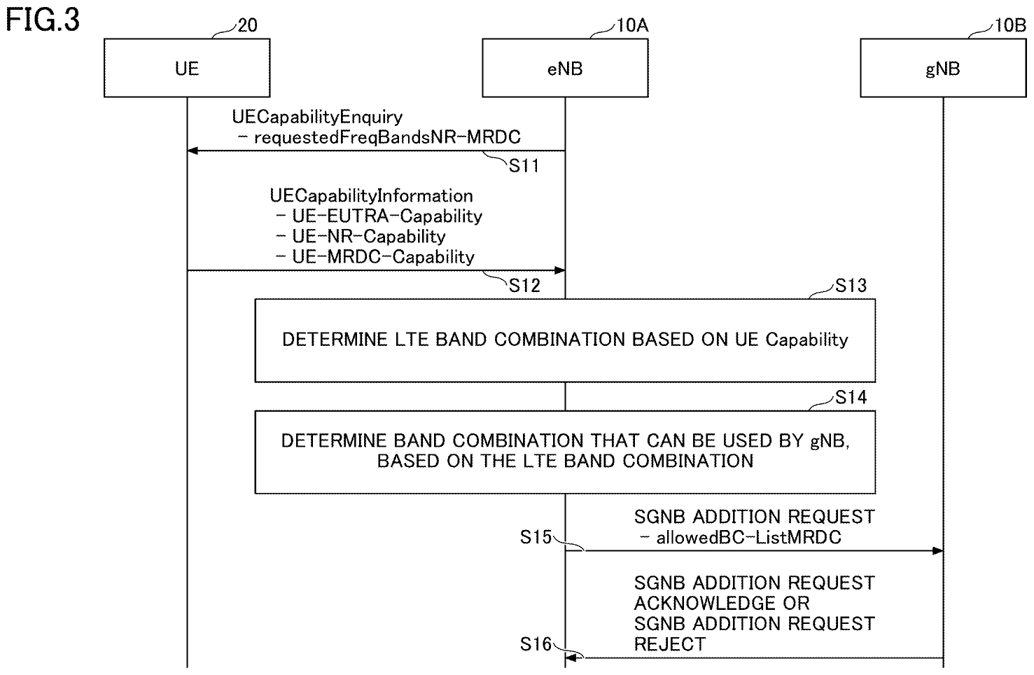

FIG. 3 is an example of adding a secondary node in an embodiment of the present invention. With respect to the UE capability for EN-DC (EUTRA-NR Dual Connectivity), signaling is reduced by indicating, from the eNB 10A to the UE 20, the target bands, a bandwidth of each band, a number of component carriers, and the like, and by reporting, from the UE 20 to the eNB 10A, only corresponding bands.

In step S11, an eNB 10A includes requestedFreqBandsNR-MRDC in UECapabilityEnquiry to be transmitted to a UE 20. In subsequent step S12, the UE 20 determines UE-EUTRA-Capability, UE-NR-Capability, and UE-MRDC-Capability as UECapabilityInformation corresponding to bands that are specified by requestedFreqBandsNR-MRDC to be transmitted to the eNB 10A. The UE-EUTRA-Capability indicates a UE capability related to EUTRA, the UE-NR-Capability indicates a UE capability related to NR, and the UE-MRDC-Capability indicates a UE capability related to MRDC.

In step S13, the eNB 10A determines LTE band combinations, based on a report, UECapabilityInformation, from the UE 20. In subsequent step S14, the eNB 10A determines allowedBC-ListMRDC that includes band combinations that can be used by the gNB, based on the LTE band combinations.

In subsequent step S15, the eNB 10A transmits SGNB ADDITION REQUEST including the allowedBC-ListMRDC to a gNB 10B. In a case where supported band combinations are included in the allowedBC-ListMRDC, the gNB 10B may transmit SGNB ADDITION REQUEST ACKNOWLEDGE to the eNB 10A, EN-DC may be started, and the UE 20 may perform communication with the eNB 10A and the gNB 10B.

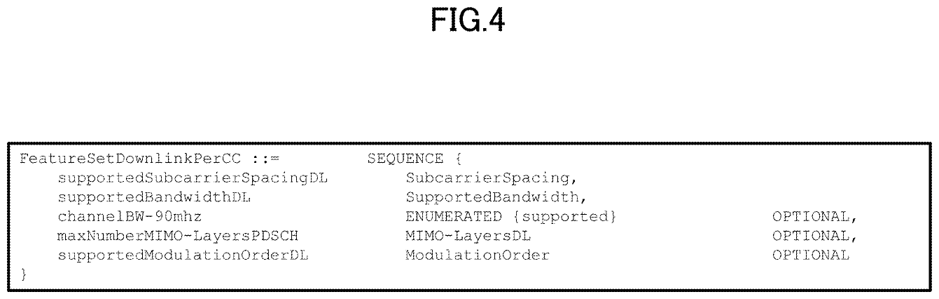

Here, the eNB 10A does not refer to the NR-specific UE capability that is the UE-NR-Capability. As a result, when determining the allowedBC-ListMRDC, for example, NR parameters such as an SCS supported by UE for each CC of each NR band (supportedSubcarrierSpacingDL) and a maximum bandwidth supported by UE for each CC of each NR band (supportedBandwidthDL) as illustrated in FIG. 4 cannot be taken into account.

Therefore, in a case where only band combinations with an SCS or a bandwidth that are not supported by the gNB 10B are configured in the allowedBC-ListMRDC, the gNB 10B cannot start EN-DC, and, in step S16, SGNB ADDITION REQUEST REJECT is transmitted from the gNB 10B to the eNB 10A, and the secondary node addition fails.

For example, in a case where the allowedBC-ListMRDC includes NR B78 corresponding to the 60 MHz bandwidth and the gNB 10B does not support NR B78 with 60 MHz bandwidth, SGNB ADDITION REQUEST REJECT is transmitted from the gNB 10B to the eNB 10A, and the secondary node addition fails.

Therefore, NR bands of NR parameters that are not supported by the gNB 10B may be caused to not be reported from the UE 20 to the eNB 10A. For example, in the UECapabilityEnquiry, only parameters (for example, SCS, bandwidth, number of CCs, etc.) that are supported by the gNB 10B may be allowed to be requested.

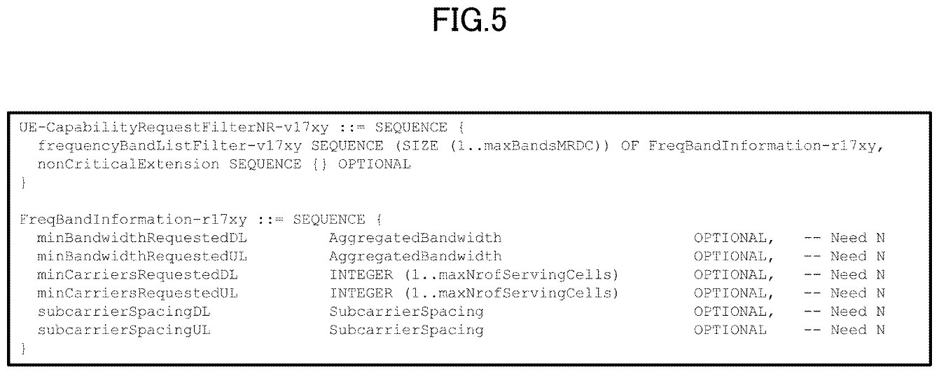

FIG. 5 is a drawing illustrating an example of a UE capability inquiry in an embodiment of the present invention. As illustrated in FIG. 5, UE-CapabilityRequestFilterNR-v17xy may be introduced to the UECapabilityEnquiry. The UE-CapabilityRequestFilterNR-v17xy may include a parameter, FreqBandInformation-r17xy, that is applied to each band that is supported by the gNB 10B. The parameter is supported by the gNB 10B. A part of the FreqBandInformation-r17xy illustrated in FIG. 5 may be configured, or the entirety of the FreqBandInformation-r17xy illustrated in FIG. 5 may be configured.

As illustrated in FIG. 5, the FreqBandInformation-r17xy may include some of or all of the minimum value of the bandwidth of DL CC (minBandwidthRequestedDL), the minimum value of the bandwidth of UL CC (minBandwidthRequestedUL), the minimum number of DL CCs (minCarriersRequestedDL), the minimum number of UL CCs (minCarriersRequestedUL), DL SCS (subcarrierSpacingDL), and UL SCS (subcarrierSpacingUL) in the target band.

In addition, the FreqBandInformation-r17xy may include some of or all of a choice of DL bandwidth, a choice of UL bandwidth, a choice of the number of DL CCs, a choice of the number of UL CCs, a choice of DL SCS, and a choice of UL SCS in the target band. The above-described choices may include one or more elements.

In addition, the band indicated by each FreqBandInformation-r17xy may correspond to each entry of FreqBandList of frequencyBandListFilter included in the UE-CapabilityRequestFilterNR in the order of the entries, or may be explicitly indicated by FreqBandIndicatorNR.

In response to receiving the UECapabilityEnquiry including the UE-CapabilityRequestFilterNR-v17xy, the UE 20 reports UE-MRDC-Capability and UE-NR-Capability whose contents are narrowed down according to the filtering based on the UE-CapabilityRequestFilterNR-v17xy to the eNB 10A. The UE 20 may perform communication with the eNB 10A and the gNB 10B according to EN-DC that is started based on the reported UE capability.

According to an embodiment of the present invention described above, when determining the band combinations that can be used by the gNB, the eNB can determine the band combinations supported by the gNB by referring to the NR-specific UE capability and can add the gNB as a secondary node without failure.

In other words, reliability when adding a secondary node in a wireless communication system can be improved.

### (Device Configuration)

Next, a functional configuration example of the base station 10 and the terminal 20 for performing the processes and operations described above will be described. The base station 10 and terminal 20 include functions for implementing the embodiments described above. It should be noted, however, that each of the base stations 10 and the terminal 20 may include only proposed functions in one of the embodiments.

### <Base Station 10>

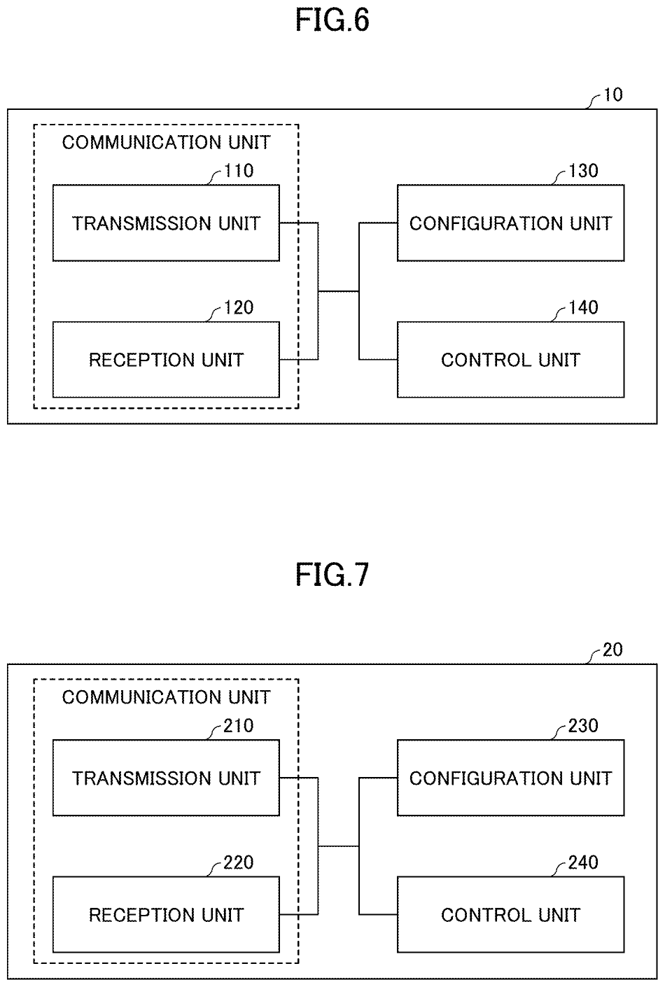

FIG. 6 is a diagram illustrating an example of a functional configuration of the base station 10. As shown in FIG. 6, the base station 10 includes a transmission unit 110, a reception unit 120, a configuration unit 130, and a control unit 140. The functional structure illustrated in FIG. 6 is merely an example. Functional divisions and names of functional units may be anything as long as operations according to an embodiment of the present invention can be performed. The transmission unit 110 and the reception unit 120 may be referred to as a communication unit.

The transmission unit 110 includes a function for generating a signal to be transmitted to the terminal 20 side and transmitting the signal wirelessly. The reception unit 120 includes a function for receiving various signals transmitted from the terminal 20 and acquiring, for example, information of a higher layer from the received signals. Further, the transmission unit 110 has a function of transmitting NR-PSS, NR-SSS, NR-PBCH, DL/UL control signals, the DL data, and the like, to the terminal 20. In addition, the transmission unit 110 transmits configuration information, or the like, described in the embodiment.

The configuration unit 130 stores preset configuration information and various configuration information items to be transmitted to the terminal 20 in a storage apparatus and reads the preset configuration information from the storage apparatus if necessary. The control unit 140 performs, for example, resource allocation and control of the entire base station 10. Note the functional unit related to signal transmission in the control unit 140 may be included in the transmission unit 110, and the functional unit related to signal reception in the control unit 140 may be included in the reception unit 120. Further, the transmission unit 110 and the reception unit 120 may be referred to as a transmitter and a receiver, respectively.

### <Terminal 20>

FIG. 7 is a diagram illustrating an example of a functional configuration of the terminal 20. As shown in FIG. 7, the terminal 20 includes a transmission unit 210, a reception unit 220, a configuration unit 230, and a control unit 240. The functional structure illustrated in FIG. 7 is merely an example. Functional divisions and names of functional units may be anything as long as operations according to an embodiment of the present invention can be performed. The transmission unit 210 and the reception unit 220 may be referred to as a communication unit.

The transmission unit 210 generates a transmission signal from transmission data and transmits the transmission signal wirelessly. The reception unit 220 receives various signals wirelessly and obtains upper layer signals from the received physical layer signals. In addition, the transmission unit 210 transmits a HARQ-ACK, and the reception unit 220 receives configuration information described in the embodiment.

The configuration unit 230 stores, in a storage device, various configuration information items received from the base station 10 via the reception unit 220, and reads them from the storage device if necessary. In addition, the configuration unit 230 also stores pre-configured configuration information. The control unit 240 controls the entire terminal 20. Note the functional unit related to signal transmission in the control unit 240 may be included in the transmission unit 210, and the functional unit related to signal reception in the control unit 240 may be included in the reception unit 220. Further, the transmission unit 210 and the reception unit 220 may be referred to as a transmitter and a receiver, respectively.

### (Hardware Structure)

In the above functional structure diagrams used for describing an embodiment of the present invention (FIG. 6 and FIG. 7), functional unit blocks are shown. The functional blocks (function units) are realized by a freely-selected combination of hardware and/or software. Further, realizing means of each functional block is not limited in particular. In other words, each functional block may be realized by a single apparatus in which multiple elements are coupled physically and/or logically, or may be realized by two or more apparatuses that are physically and/or logically separated and are physically and/or logically connected (e.g., wired and/or wireless). The functional blocks may be realized by combining the above-described one or more apparatuses with software.

Functions include, but are not limited to, judging, determining, calculating, processing, deriving, investigating, searching, checking, receiving, transmitting, outputting, accessing, resolving, selecting, establishing, comparing, assuming, expecting, and deeming; broadcasting, notifying, communicating, forwarding, configuring, reconfiguring, allocating, mapping, and assigning, etc. For example, a functional block (component) that functions to transmit is called a transmitting unit or a transmitter. In either case, as described above, the implementation method is not particularly limited.

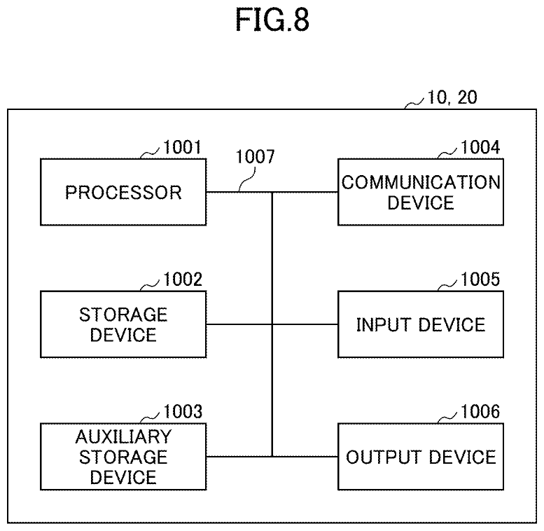

For example, the base station 10, terminal 20, etc., according to an embodiment of the present disclosure may function as a computer for processing the radio communication method of the present disclosure. FIG. 8 is a drawing illustrating an example of hardware structures of the base station 10 and terminal 20 according to an embodiment of the present invention. Each of the above-described base station 10 and the terminal 20 may be physically a computer device including a processor 1001, a storage device 1002, an auxiliary storage device 1003, a communication device 1004, an input device 1005, an output device 1006, a bus 1007, etc.

It should be noted that, in the descriptions below, the term “apparatus” can be read as a circuit, a device, a unit, etc. The hardware structures of the base station 10 and terminal 20 may include one or more of each of the devices illustrated in the figure, or may not include some devices.

Each function in the base station 10 and terminal 20 is realized by having the processor 1001 perform an operation by reading predetermined software (programs) onto hardware such as the processor 1001 and the storage device 1002, and by controlling communication by the communication device 1004 and controlling at least one of reading and writing of data in the storage device 1002 and the auxiliary storage device 1003.

The processor 1001 controls the entire computer by, for example, controlling the operating system. The processor 1001 may include a central processing unit (CPU) including an interface with a peripheral apparatus, a control apparatus, a calculation apparatus, a register, etc. For example, the above-described control unit 140, control unit 240, and the like, may be implemented by the processor 1001.

Further, the processor 1001 reads out onto the storage device 1002 a program (program code), a software module, or data from the auxiliary storage device 1003 and/or the communication device 1004, and performs various processes according to the program, the software module, or the data. As the program, a program is used that causes the computer to perform at least a part of operations according to an embodiment of the present invention described above. For example, the control unit 140 of the base station 10 illustrated in FIG. 6 may be realized by control programs that are stored in the storage device 1002 and are executed by the processor 1001. Further, for example, the control unit 240 of the terminal 20 illustrated in FIG. 7 may be realized by control programs that are stored in the storage device 1002 and are executed by the processor 1001. The various processes have been described to be performed by a single processor 1001. However, the processes may be performed by two or more processors 1001 simultaneously or sequentially. The processor 1001 may be implemented by one or more chips. It should be noted that the program may be transmitted from a network via a telecommunication line.

The storage device 1002 is a computer-readable recording medium, and may include at least one of a ROM (Read Only Memory), an EPROM (Erasable Programmable ROM), an EEPROM (Electrically Erasable Programmable ROM), a RAM (Random Access Memory), etc. The storage device 1002 may be referred to as a register, a cache, a main memory, etc. The storage device 1002 is capable of storing programs (program codes), software modules, or the like, that are executable for performing communication processes according to an embodiment of the present invention.

The auxiliary storage device 1003 is a computer-readable recording medium, and may include at least one of, for example, an optical disk such as a CD-ROM (Compact Disc ROM), a hard disk drive, a flexible disk, a magneto optical disk (e.g., compact disc, digital versatile disc, Blu-ray (registered trademark) disk), a smart card, a flash memory (e.g., card, stick, key drive), a floppy (registered trademark) disk, a magnetic strip, etc. The above recording medium may be a database including the storage device 1002 and/or the auxiliary storage device 1003, a server, or any other appropriate medium.

The communication device 1004 is hardware (transmission and reception device) for communicating with computers via at least one of a wired network and a wireless network, and may be referred to as a network device, a network controller, a network card, a communication module, etc. The communication device 1004 may comprise a high frequency switch, duplexer, filter, frequency synthesizer, or the like, for example, to implement at least one of a frequency division duplex (FDD) and a time division duplex (TDD). For example, the transmitting/receiving antenna, the amplifier unit, the transmitting/receiving unit, the transmission line interface, and the like, may be implemented by the communication device 1004. The transmitting/receiving unit may be physically or logically divided into a transmitting unit and a receiving unit.

The input device 1005 is an input device that receives an external input (e.g., keyboard, mouse, microphone, switch, button, sensor). The output device 1006 is an output device that outputs something to the outside (e.g., display, speaker, LED lamp). It should be noted that the input device 1005 and the output device 1006 may be integrated into a single device (e.g., touch panel).

Further, the apparatuses including the processor 1001, the storage device 1002, etc., are connected to each other via the bus 1007 used for communicating information. The bus 1007 may 1007 may include a single bus, or may include different buses between the apparatuses.

Further, each of the base station 10 and terminal 20 may include hardware such as a microprocessor, a digital signal processor (DSP), an ASIC (Application Specific Integrated Circuit), a PLD (Programmable Logic Device), a FPGA (Field Programmable Gate Array), etc., and a part or all of each functional block may be realized by the hardware. For example, the processor 1001 may be implemented by at least one of the above hardware elements.

### Embodiment Summary

As described above, according to an embodiment of the present invention, a terminal is provided. The terminal includes: a reception unit configured to receive an inquiry related to terminal capability including bands and a parameter from a first base station, the bands being supported by a second base station that performs communication together with the first base station according to DC (Dual Connectivity) and the parameter being supported by the second base station in the bands; a control unit configured to determine the terminal capability corresponding to the bands and the parameter; and a transmission unit configured to transmit a report related to the determined terminal capability to the first base station.

According to the above-described configuration, when determining the band combinations that can be used by the gNB, the eNB can determine the band combinations supported by the gNB by referring to the NR-specific UE capability and can add the gNB as a secondary node without failure. In other words, reliability when adding a secondary node in a wireless communication system can be improved.

The parameter may include at least one of a bandwidth of a component carrier, a number of component carriers, and a subcarrier spacing, in each band supported by the second base station. According to the above-described configuration, when determining the band combinations that can be used by the gNB, the eNB can determine the band combinations supported by the gNB by referring to the NR-specific UE capability and can add the gNB as a secondary node without failure.

The reception unit and the transmission unit may perform communication with the first base station and the second base station according to the DC that is started based on the report of the terminal capability. According to the above-described configuration, when determining the band combinations that can be used by the gNB, the eNB can determine the band combinations supported by the gNB by referring to the NR-specific UE capability and can add the gNB as a secondary node without failure.

In addition, according to an embodiment of the present invention, a communication method performed by a terminal is provided. The communication method includes: receiving an inquiry related to terminal capability including bands and a parameter, the bands being supported by a second base station that performs communication together with a first base station according to DC (Dual Connectivity) and the parameter being supported by the second base station in the bands; determining the terminal capability corresponding to the bands and the parameter; and transmitting a report related to the determined terminal capability to the first base station.

According to the above-described configuration, when determining the band combinations that can be used by the gNB, the eNB can determine the band combinations supported by the gNB by referring to the NR-specific UE capability and can add the gNB as a secondary node without failure. In other words, reliability when adding a secondary node in a wireless communication system can be improved.

### Supplement of Embodiment

As described above, one or more embodiments have been described. The present invention is not limited to the above embodiments. A person skilled in the art should understand that there are various modifications, variations, alternatives, replacements, etc., of the embodiments. In order to facilitate understanding of the present invention, specific values have been used in the description. However, unless otherwise specified, those values are merely examples and other appropriate values may be used. The division of the described items may not be essential to the present invention. The things that have been described in two or more items may be used in a combination if necessary, and the thing that has been described in one item may be appropriately applied to another item (as long as there is no contradiction). Boundaries of functional units or processing units in the functional block diagrams do not necessarily correspond to the boundaries of physical parts. Operations of multiple functional units may be physically performed by a single part, or an operation of a single functional unit may be physically performed by multiple parts. The order of sequences and flowcharts described in an embodiment of the present invention may be changed as long as there is no contradiction. For the sake of description convenience, the base station 10 and the terminal 20 have been described by using functional block diagrams. However, the apparatuses may be realized by hardware, software, or a combination of hardware and software. The software executed by a processor included in the base station 10 according to an embodiment of the present invention and the software executed by a processor included in the terminal 20 according to an embodiment of the present invention may be stored in a random access memory (RAM), a flash memory, a read only memory (ROM), an EPROM, an EEPROM, a register, a hard disk (HDD), a removable disk, a CD-ROM, a database, a server, or any other appropriate recording medium.

Further, information indication may be performed not only by methods described in an aspect/embodiment of the present specification but also a method other than those described in an aspect/embodiment of the present specification. For example, the information transmission may be performed by physical layer signaling (e.g., DCI (Downlink Control Information), UCI (Uplink Control Information)), upper layer signaling (e.g., RRC (Radio Resource Control) signaling, MAC (Medium Access Control) signaling, broadcast information (MIB (Master Information Block), SIB (System Information Block))), other signals, or combinations thereof. Further, RRC signaling may be referred to as an RRC message. The RRC signaling may be, for example, an RRC connection setup message, an RRC connection reconfiguration message, or the like.

Each aspect/embodiment described in the present disclosure may be applied to at least one of a system using LTE (Long Term Evolution), LTE-A (LTE-Advanced), SUPER 3G, IMT-Advanced, 4G (4th generation mobile communication system), 5G (5th generation mobile communication system), FRA (Future Radio Access), NR (new Radio), W-CDMA (registered trademark), GSM (registered trademark), CDMA2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), and other appropriate systems, and a next generation system enhanced therefrom. Further, multiple systems may also be applied in combination (e.g., at least one of LTE and LTE-A combined with 5G, etc.).

The order of processing steps, sequences, flowcharts or the like of an aspect/embodiment described in the present specification may be changed as long as there is no contradiction. For example, in a method described in the present specification, elements of various steps are presented in an exemplary order. The order is not limited to the presented specific order.

The particular operations that are supposed to be performed by the base station 10 in the present specification may be performed by an upper node in some cases. In a network including one or more network nodes including the base station 10, it is apparent that various operations performed for communicating with the terminal 20 may be performed by the base station 10 and/or another network node other than the base station 10 (for example, but not limited to, MME or S-GW). According to the above, a case is described in which there is a single network node other than the base station 10. However, a combination of multiple other network nodes may be considered (e.g., MME and S-GW).

The information or signals described in this disclosure may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A decision or a determination in an embodiment of the present invention may be Realized by a value (0 or 1) represented by one bit, by a boolean value (true or false), or by comparison of numerical values (e.g., comparison with a predetermined value).

Software should be broadly interpreted to mean, whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL) and wireless technologies (infrared, microwave, etc.), at least one of these wired line technologies and wireless technologies is included within the definition of the transmission medium.

Information, a signal, or the like, described in the present specification may be represented by using any one of various different technologies. For example, data, an instruction, a command, information, a signal, a bit, a symbol, a chip, or the like, described throughout the present application, may be represented by a voltage, an electric current, electromagnetic waves, magnetic fields, a magnetic particle, optical fields, a photon, or a combination thereof.

It should be noted that a term used in the present specification and/or a term required for understanding of the present specification may be replaced by a term having the same or similar meaning. For example, a channel and/or a symbol may be a signal (signaling). Further, a signal may be a message. Further, the component carrier (CC) may be referred to as a carrier frequency, cell, frequency carrier, or the like.

As used in the present disclosure, the terms “system” and “network” are used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

In the present disclosure, the terms “BS: Base Station”, “Radio Base Station”, “Base Station”, “Fixed Station”, “NodeB”, “eNodeB (eNB)”, “gNodeB (gNB)”, “Access Point”, “Transmission Point”, “Reception Point”, “Transmission/Reception Point”, “Cell”, “Sector”, “Cell Group”, “Carrier”, “Component Carrier”, and the like, may be used interchangeably. The base station may be referred to as a macro-cell, a small cell, a femtocell, a picocell and the like.

The base station may accommodate (provide) one or more (e.g., three) cells. In the case where the base station accommodates a plurality of cells, the entire coverage area of the base station may be divided into a plurality of smaller areas, each smaller area may provide communication services by means of a base station subsystem (e.g., an indoor small base station or a remote Radio Head (RRH)). The term “cell” or “sector” refers to a part or all of the coverage area of at least one of the base station and base station subsystem that provides communication services at the coverage.

In the present disclosure, terms such as “mobile station (MS)”, “user terminal”, “user equipment (UE)”, “terminal”, and the like, may be used interchangeably.

There is a case in which the mobile station may be referred to, by a person skilled in the art, as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other appropriate terms.

At least one of the base station and the mobile station may be referred to as a transmission apparatus, reception apparatus, communication apparatus, or the like. The at least one of the base station and the mobile station may be a device mounted on the mobile station, the mobile station itself, or the like. The mobile station may be a vehicle (e.g., a car, an airplane, etc.), an unmanned mobile body (e.g., a drone, an automated vehicle, etc.), or a robot (manned or unmanned). At least one of the base station and the mobile station may include an apparatus that does not necessarily move during communication operations. For example, at least one of the base station and the mobile station may be an IoT (Internet of Things) device such as a sensor.

Further, the base station in the present disclosure may be read as the user terminal. For example, each aspect/embodiment of the present disclosure may be applied to a configuration in which communications between the base station and the user terminal are replaced by communications between multiple terminals 20 (e.g., may be referred to as D2D (Device-to-Device), V2X (Vehicle-to-Everything), etc.). In this case, the function of the base station 10 described above may be provided by the terminal 20. Further, the phrases “up” and “down” may also be replaced by the phrases corresponding to terminal-to-terminal communication (e.g., “side”). For example, an uplink channel, a downlink channel, or the like, may be read as a sidelink channel.

Further, the user terminal in the present disclosure may be read as the base station. In this case, the function of the user terminal described above may be provided by the base station.

The term “determining” used in the present specification may include various actions or operations. The “determining” may include, for example, a case in which “judging”, “calculating”, “computing”, “processing”, “deriving”, “investigating”, “looking up, search, inquiry” (e.g., looking up a table, database, or other data structures), or “ascertaining” is deemed as “determining”. Further, the “determining” may include a case in which “receiving” (e.g., receiving information), “transmitting” (e.g., transmitting information), “inputting”, “outputting”, or “accessing” (e.g., accessing data in a memory) is deemed as “determining”. Further, the “determining” may include a case in which “resolving”, “selecting”, “choosing”, “establishing”, “comparing”, or the like is deemed as “determining”. In other words, the “determining” may include a case in which a certain action or operation is deemed as “determining”. Further, “decision” may be read as “assuming”, “expecting”, or “considering”, etc.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of the one or more wires, cables, and printed electrical connections and, as a number of non-limiting and non-inclusive examples, electromagnetic energy having wavelengths in the radio frequency region, the microwave region, and the light (both visible and invisible) region.

The reference signal may be abbreviated as RS or may be referred to as a pilot, depending on the applied standards.

The description “based on” used in the present specification does not mean “based on only” unless otherwise specifically noted. In other words, the phrase “based on” means both “based on only” and “based on at least”.

Any reference to an element using terms such as “first” or “second” as used in the present disclosure does not generally limit the amount or the order of those elements. These terms may be used in the present disclosure as a convenient way to distinguish between two or more elements. Therefore, references to the first and second elements do not imply that only two elements may be employed or that the first element must in some way precede the second element.

“Means” included in the configuration of each of the above apparatuses may be replaced by “parts”, “circuits”, “devices”, etc.

In the case where the terms “include”, “including” and variations thereof are used in the present disclosure, these terms are intended to be comprehensive in the same way as the term “comprising”. Further, the term “or” used in the present specification is not intended to be an “exclusive or”.

A radio frame may include one or more frames in the time domain. Each of the one or more frames in the time domain may be referred to as a subframe. The subframe may further include one or more slots in the time domain. The subframe may be a fixed length of time (e.g., 1 ms) independent from the numerology.

The numerology may be a communication parameter that is applied to at least one of the transmission and reception of a signal or channel. The numerology may indicate at least one of, for example, SubCarrier Spacing (SCS), bandwidth, symbol length, cyclic prefix length, transmission time interval (TTI), number of symbols per TTI, radio frame configuration, specific filtering processing performed by the transceiver in the frequency domain, and specific windowing processing performed by the transceiver in the time domain.

The slot may include one or more symbols in the time domain, such as OFDM (Orthogonal Frequency Division Multiplexing) symbols, SC-FDMA (Single Carrier Frequency Division Multiple Access) symbols, and the like. The slot may be a time unit based on the numerology.

The slot may include a plurality of mini slots. Each mini slot may include one or more symbols in the time domain. Further, the mini slot may be referred to as a sub-slot. The mini slot may include fewer symbols than the slot. PDSCH (or PUSCH) transmitted in time units greater than a mini slot may be referred to as PDSCH (or PUSCH) mapping type A. PDSCH (or PUSCH) transmitted using a mini slot may be referred to as PDSCH (or PUSCH) mapping type B.

A radio frame, a subframe, a slot, a mini slot and a symbol all represent time units for transmitting signals. Different terms may be used for referring to a radio frame, a subframe, a slot, a mini slot and a symbol, respectively.

For example, one subframe may be referred to as a transmission time interval (TTI), multiple consecutive subframes may be referred to as a TTI, and one slot or one mini slot may be referred to as a TTI. In other words, at least one of the subframe and the TTI may be a subframe (1 ms) in an existing LTE, a period shorter than 1 ms (e.g., 1-13 symbols), or a period longer than 1 ms. It should be noted that the unit representing the TTI may be referred to as a slot, a mini slot, or the like, rather than a subframe.

The TTI refers to, for example, the minimum time unit for scheduling in wireless communications. For example, in an LTE system, a base station schedules each terminal 20 to allocate radio resources (such as frequency bandwidth, transmission power, etc. that can be used in each terminal 20) in TTI units. The definition of TTI is not limited to the above.

The TTI may be a transmission time unit, such as a channel-encoded data packet (transport block), code block, codeword, or the like, or may be a processing unit, such as scheduling or link adaptation. It should be noted that, when a TTI is provided, the time interval (e.g., the number of symbols) during which the transport block, code block, codeword, or the like, is actually mapped may be shorter than the TTI.

It should be noted that, when one slot or one mini slot is referred to as a TTI, one or more TTIs (i.e., one or more slots or one or more mini slots) may be the minimum time unit for scheduling. Further, the number of slots (the number of mini slots) constituting the minimum time unit of the scheduling may be controlled.

A TTI having a time length of 1 ms may be referred to as a normal TTI (a TTI in LTE Rel. 8-12), a long TTI, a normal subframe, a long subframe, a slot, and the like. A TTI that is shorter than the normal TTI may be referred to as a shortened TTI, a short TTI, a partial TTI (or fractional TTI), a shortened subframe, a short subframe, a mini slot, a subslot, a slot, or the like.

It should be noted that the long TTI (e.g., normal TTI, subframe, etc.) may be replaced with a TTI having a time length exceeding 1 ms, and the short TTI (e.g., shortened TTI, etc.) may be replaced with a TTI having a TTI length less than the TTI length of the long TTI and a TTI length greater than 1 ms.

A resource block (RB) is a time domain and frequency domain resource allocation unit and may include one or more consecutive subcarriers in the frequency domain. The number of subcarriers included in an RB may be the same, regardless of the numerology, and may be 12, for example. The number of subcarriers included in an RB may be determined on the basis of numerology.

Further, the time domain of an RB may include one or more symbols, which may be 1 slot, 1 mini slot, 1 subframe, or 1 TTI in length. One TTI, one subframe, etc., may each include one or more resource blocks.

It should be noted that one or more RBs may be referred to as physical resource blocks (PRBs, Physical RBs), sub-carrier groups (SCGs), resource element groups (REGs), PRB pairs, RB pairs, and the like.

Further, a resource block may include one or more resource elements (RE). For example, 1 RE may be a radio resource area of one sub-carrier and one symbol.

The bandwidth part (BWP) (which may also be referred to as a partial bandwidth, etc.) may represent a subset of consecutive common RBs (common resource blocks) for a given numerology in a carrier. Here, a common RB may be identified by an index of RB relative to the common reference point of the carrier. A PRB may be defined in a BWP and may be numbered within the BWP.

BWP may include BWP for UL (UL BWP) and BWP for DL (DL BWP). For a terminal 20, one or more BWPs may be configured in one carrier.

At least one of the configured BWPs may be activated, and the terminal 20 may assume that the terminal 20 will not transmit and receive signals/channels outside the activated BWP. It should be noted that the terms “cell” and “carrier” in this disclosure may be replaced by “BWP.”

Structures of a radio frame, a subframe, a slot, a mini slot, and a symbol described above are exemplary only. For example, the number of subframes included in a radio frame, the number of slots per subframe or radio frame, the number of mini slots included in a slot, the number of symbols and RBs included in a slot or mini slot, the number of subcarriers included in an RB, the number of symbols in a TTI, the symbol length, the cyclic prefix (CP) length, and the like, may be changed in various ways.

In the present disclosure, where an article is added by translation, for example “a”, “an”, and “the”, the disclosure may include that the noun following these articles is plural.

In this disclosure, the term “A and B are different” may mean “A and B are different from each other.” It should be noted that the term “A and B are different” may mean “A and B are different from C.” Terms such as “separated” or “combined” may be interpreted in the same way as the above-described “different”.

Each aspect/embodiment described in the present specification may be used independently, may be used in combination, or may be used by switching according to operations. Further, notification (transmission/reporting) of predetermined information (e.g., notification (transmission/reporting) of “X”) is not limited to an explicit notification (transmission/reporting), and may be performed by an implicit notification (transmission/reporting) (e.g., by not performing notification (transmission/reporting) of the predetermined information).

In addition, in the present disclosure, the UECapabilityEnquiry is an example of an inquiry related to the terminal capability. The UECapabilityInformation is an example of a report related to the terminal capability.

As described above, the present invention has been described in detail. It is apparent to a person skilled in the art that the present invention is not limited to one or more embodiments of the present invention described in the present specification. Modifications, alternatives, replacements, etc., of the present invention may be possible without departing from the subject matter and the scope of the present invention defined by the descriptions of claims. Therefore, the descriptions of the present specification are for illustrative purposes only, and are not intended to be limitations to the present invention.

### DESCRIPTION OF THE REFERENCE NUMERALS

10 Base station
110 Transmission unit
120 Reception unit
130 Configuration unit
140 Control unit
20 Terminal
210 Transmission unit
220 Reception unit
230 Configuration unit
240 Control unit
1001 Processor
1002 Storage device
1003 Auxiliary storage device
1004 Communication device
1005 Input device
1006 Output device

1. A terminal comprising:
a reception unit configured to receive an inquiry related to terminal capability including bands and a parameter from a first base station, the bands being supported by a second base station that performs communication together with the first base station according to DC (Dual Connectivity), and the parameter being supported by the second base station in the bands;
a control unit configured to determine the terminal capability corresponding to the band and the parameter; and
a transmission unit configured to transmit a report related to the determined terminal capability to the first base station.

2. The terminal as claimed in claim 1, wherein
the parameter includes at least one of a bandwidth of a component carrier, a number of component carriers, and a subcarrier spacing, in each band supported by the second base station.

3. The terminal as claimed in claim 2, wherein
the reception unit and the transmission unit perform communication with the first base station and the second base station according to the DC that is started based on the report of the terminal capability.

4. A communication method performed by a terminal, the communication method comprising:
receiving an inquiry related to terminal capability including bands and a parameter from a first base station, the bands being supported by a second base station that performs communication together with the first base station according to DC (Dual Connectivity), and the parameter being supported by the second base station in the bands;
determining the terminal capability corresponding to the band and the parameter; and
transmitting a report related to the determined terminal capability to the first base station.
